(19) United States
(12) Patent Application Publication
(10) Pub. No.: US 2007/0068489 A1
(43) Pub. Date: Mar. 29, 2007

(54) Control device of internal combustion engine

(75) Inventors: Naoki Osumi, Chiryu-city (JP); Masahiro Ito, Toyota-city (JP); Kenji Kasashima, Nishikamo-gun (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); TOYOTA JIDOSHA KABUSHIKI KAISHA, Toyota-city (JP)

(21) Appl. No.: 11/527,705

(22) Filed: Sep. 27, 2006

(30) Foreign Application Priority Data
Sep. 27, 2005 (JP) 2005-279237

(51) Int. Cl. F02D 41/00; F02D 11/10; G06F 19/00

(52) U.S. Cl. 123/361; 123/399; 701/110

(57) ABSTRACT

A control device of an engine is disclosed that includes a steady controlled variable computing device for computing a steady controlled variable appropriate for a steady operation of the engine. The control device also includes a transient controlled variable computing device for computing a transient controlled variable appropriate for a transient operation of the engine. Furthermore, the control device includes controller that compares the steady controlled variable with the transient controlled variable and selects one of the steady controlled variable and the transient controlled variable on the basis of the comparison. A method of controlling the engine is also disclosed.

### CROSS REFERENCE TO RELATED APPLICATION(S)

The following is based on and claims priority on Japanese Patent Application No. 2005-279237, filed Sep. 27, 2005, which is hereby incorporated herein by reference.

### FIELD OF THE INVENTION

The present invention relates to a control device of an engine that controls the operation of the internal combustion engine by switching between an engine controlled variable appropriate for the steady operation of the internal combustion engine and an engine controlled variable appropriate for the transient operation of the internal combustion engine.

### BACKGROUND OF THE INVENTION

It is known to provide an engine controller for improving engine response to a driver's accelerator operation. For instance, in Japanese Patent Publication No. 11-022515A, torque required by a driver (i.e., target torque) is computed from an accelerator position, a target throttle opening is computed from the target torque, and an actual throttle opening is controlled to realize the target throttle opening.

During transient engine operations, drivability can be improved by increasing response of the target throttle opening to changes in target torque (e.g., due to changes in accelerator position and the like). However, during steady engine operation, over-sensitivity of the target throttle opening can impair drivability. For instance, if the target throttle opening is overly sensitive during steady engine operation, the accelerator position can be vibrated due to running vibration of the vehicle to thereby impair drivability.

Hence, it can be determined whether an engine is in a steady state or in a transient state based on the engine operating condition. When the engine is determined to be in the transient state, the target throttle opening can be computed by the method of Japanese Patent Publication No. 11-022515A. On the other hand, when the engine is determined to be in the steady state, the target throttle opening can be set so as to give a higher-priority to stability than to responsivity-to-change of the target torque.

However, when a vehicle is running in the steady state and the target torque is vibrated by noise in the acceleration sensor and the like, the vibration can cause erroneous detection of an engine transient state. As a result, although the vehicle is actually in steady state, the target throttle opening is vibrated by noise to impair stability. In addition, when the engine switches between steady and transient states, a difference between the target throttle opening before the switching and the target throttle opening after the switching can cause undesirable torque shock.

### SUMAMRY OF THE INVENTION

A control device of an engine is disclosed that includes a steady controlled variable computing device for computing a steady controlled variable appropriate for a steady operation of the engine. The control device also includes a transient controlled variable computing device for computing a transient controlled variable appropriate for a transient operation of the engine. Furthermore, the control device includes controller that compares the steady controlled variable with the transient controlled variable and selects one of the steady controlled variable and the transient controlled variable on the basis of the comparison.

A control device of an engine is also disclosed that includes a steady controlled variable computing device for computing a steady controlled variable appropriate for a steady operation of the engine. The control device also includes a transient controlled variable computing device for computing a-transient controlled variable appropriate for a transient operation of the engine. Furthermore, a smoothing processing device is included for smoothing processing of the transient controlled variable to get a smoothed value. Also, the control device includes a controller that compares the transient controlled variable with the smoothed value and selects one of the steady controlled variable and the transient controlled variable on the basis of the comparison.

Moreover, a method of controlling an engine is disclosed. The method includes computing a steady controlled variable appropriate for a steady operation of the engine. The method also includes computing a transient controlled variable appropriate for a transient operation of the engine. Additionally, the method includes comparing the steady controlled variable with the transient controlled variable and selecting one of the steady controlled variable and the transient controlled variable on the basis of the comparing.

Furthermore, a method of controlling an engine is disclosed. The method includes computing a steady controlled variable appropriate for a steady operation of the engine. The method also includes computing a transient controlled variable appropriate for a transient operation of the engine. Moreover, the method includes smoothing processing of the transient controlled variable to get a smoothed value and comparing the transient controlled variable with the smoothed value. Additionally, the method includes selecting one of the steady controlled variable and the transient controlled variable on the basis of the comparison.

### BRIEF DESCRIPTION OF THE DRAWINGS

FIG. 1 is a schematic diagram of one embodiment of an engine control system;

FIG. 2 is a schematic diagram of the engine control system of FIG. 1;

FIG. 3 is a schematic diagram of the output control device of the engine control system of FIG. 1;

FIG. 4 is a schematic diagram of a transient controlled variable computing device of the engine control system of FIG. 1;

FIG. 5 is a schematic diagram of a reverse model Ga(s) of an intake air system model;

FIG. 6 is a schematic diagram of a reverse model Gθ (s) of a throttle model;

FIG. 7 is a schematic diagram of a steady controlled variable computing device of the engine control system of FIG. 1;

FIG. 8 is a schematic diagram of a control switching device of the engine control system of FIG. 1;

FIG. 9 is a flow chart illustrating process flow of a final target throttle opening computing routine of the engine control system of FIG. 1;

FIG. 10 is a flow chart illustrating process flow of a transient target throttle opening computing routine of the engine control system of FIG. 1;

FIG. 11 is a flow chart illustrating process flow of a routine of a reverse model routine of an intake air system model;

FIG. 12 is a flow chart illustrating process flow of a routine of a reverse model of a throttle model;

FIG. 13 is a flow chart illustrating process flow of a steady target throttle opening computing routine;

FIG. 14 is a time chart illustrating behavior of a prior art engine control system and the engine control system of FIG. 1, wherein the time chart illustrates target throttle opening θt when the target intake air volume Mt is vibrated by noise of an accelerator sensor, etc. when a vehicle is running in a steady state;

FIG. 15 is a time chart illustrating behavior of a prior art engine control system and the engine control system of FIG. 1, wherein the time chart illustrates the target throttle opening θt when a driving state is switched from a steady state to a transient state;

FIG. 16 is a schematic diagram illustrating another embodiment of a control switching device; and

FIG. 17 is a schematic diagram illustrating a flow process of a final target throttle opening computing routine of the embodiment of FIG. 16.

### DETAILED DESCRIPTION

### Embodiment 1

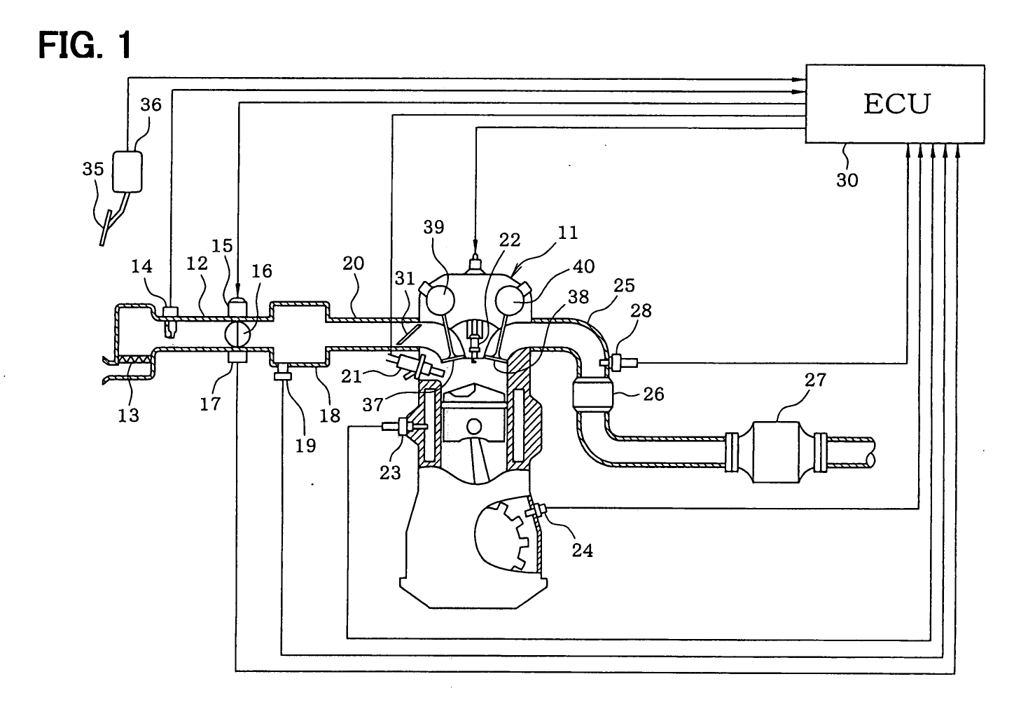

Embodiment 1 of the present invention will be described on the basis of FIG. 1 to FIG. 15. First, the general construction of an engine control system will be described on the basis of FIG. 1. An air cleaner 13 is arranged in the most upstream portion of an intake pipe 12 of a direct injection engine 11 of an internal combustion engine. An air flow meter 14 for detecting an intake air volume is arranged on the downstream side of the air cleaner 13. A throttle valve 16 is arranged on the downstream side of the air flow meter 14. A motor 15 controls the degree of opening of the throttle valve 16. A throttle opening sensor 17 is also arranged on the downstream side of the air flow meter 14. The throttle opening sensor 17 detects the degree of opening (i.e., throttle opening) of the throttle valve 16.

Moreover, a surge tank 18 is arranged on the downstream side of the throttle valve 16. The surge tank 18 is provided with an intake pipe pressure sensor 19 for detecting an intake pipe pressure. Furthermore, the surge tank 18 is provided with an intake manifold 20 for introducing air into respective cylinders of an engine 11. The intake manifold 20 of the respective cylinders is provided with airflow control valves 31, each of which controls the strength of airflow (i.e., strength of swirl flow and strength of tumble flow) in each cylinder.

A fuel injection valve 21 for injecting fuel into the cylinder is mounted on the top of each cylinder of the engine 11. An ignition plug 22 is mounted on the cylinder head of each cylinder of the engine 11, and an air-fuel mixture in each cylinder is ignited by the spark discharge of each ignition plug 22. Moreover, an intake valve 37 and an exhaust valve 38 of each cylinder of the engine 11 are provided with variable valve timing devices 39, 40 for varying the respective opening/closing timings.

The cylinder block of the engine 11 is provided with a cooling water temperature sensor 23 for detecting a cooling water temperature. Moreover, a crank angle sensor 24 is mounted on the outer peripheral side of the crankshaft (not shown), and the crank angle sensor 24 outputs a crank angle signal (i.e., pulse signal) every time the crankshaft rotates a specified crank angle. The crank angle and engine revolution speed are detected on the basis of the output pulse of the crank angle sensor 24.

An upstream catalyst 26 and a downstream catalyst 27 for cleaning exhaust gas are arranged in the exhaust pipe 25 of the engine 11. An exhaust gas sensor 28 is arranged on the upstream side of the upstream catalyst 26 (e.g., air-fuel ratio sensor, oxygen sensor, etc.) for detecting whether the air-fuel ratio or the exhaust gas is rich or lean. Moreover, an accelerator sensor 36 is included for detecting the position (i.e., the amount of depression) of an accelerator pedal 35.

The outputs of these various sensors are inputted to an engine control circuit 30 (hereinafter, “ECU”). The ECU 30 includes a microcomputer and performs various routines, which are stored in a built-in ROM (i.e., storage medium). Generally, the routines are performed to set a target throttle opening such that the output torque of the engine 11 matches a target torque (i.e., the required torque). Accordingly, an intake air volume is controlled.

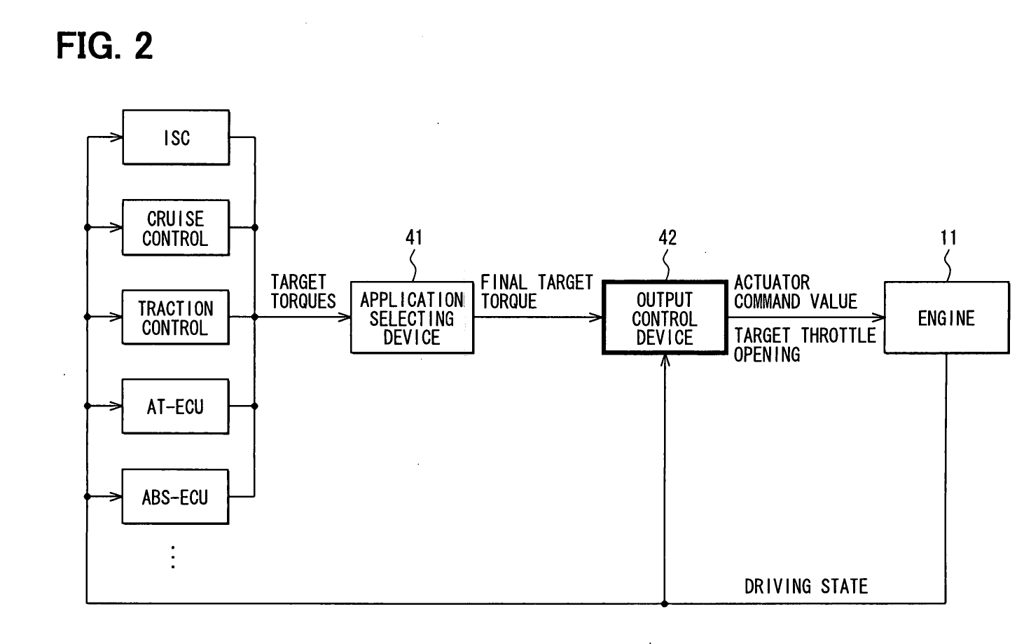

In this embodiment, as shown in FIG. 2, the ECU 30 utilizes an application selecting device 4 to select a final target torque from among target torques respectively set by an idle speed control (ISC), a cruise control, a traction control, an automatic transmission control device (AT-ECU), and an anti-lock brake system control device (ABS-ECU). Then, the ECU 30 utilizes an output control device 42 to compute an actuator command value (i.e., a target throttle opening) according to the final target torque. The ECU 30 then outputs the actuator command value to the engine 11 to control the intake air volume so as to match the final output torque of the engine 11 to the target torque.

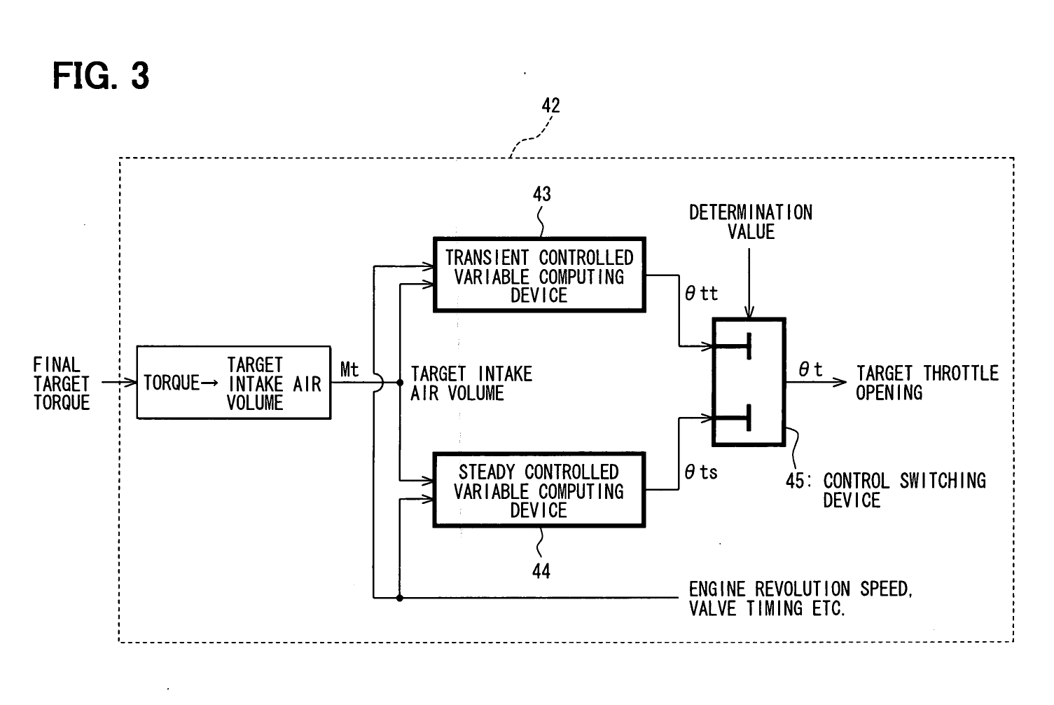

As shown in FIG. 3, the output control device 42 converts the final target torque to a target intake air volume, Mt, and outputs this target intake air volume, Mt, to a transient controlled variable computing device 43 and a steady controlled variable computing device 44. The transient controlled variable computing device 43 computes a transient target throttle opening, θtt (i.e., transient controlled variable) for realizing the target intake air volume, Mt, when operating the engine 11 in the transient state. The steady controlled variable computing device 44 computes a steady target throttle opening, θts, (i.e., steady controlled variable) for realizing the target intake air volume, Mt, when operating the engine 11 in the steady state. In this embodiment, the steady target throttle opening, θts, is a target throttle opening that gives a higher priority to stability than to responsivity-to-change in the target intake air volume, Mt. Also, the transient target throttle opening, θtt, is a target throttle opening that gives a higher priority to responsivity than to stability.

The transient target throttle opening, θtt, computed by the transient controlled variable computing device 43 and the steady target throttle opening, θts, computed by the steady controlled variable computing device 44 are inputted to the control switching device 45 (i.e., control device). The control switching device 45 compares the transient target throttle opening, θtt, with the steady target throttle opening, θts, to select either of them as a final target throttle opening, θt.

Hereinafter, the functions of the transient controlled variable computing device 43, the steady controlled variable computing device 44, and the control switching device 45 will be specifically described.

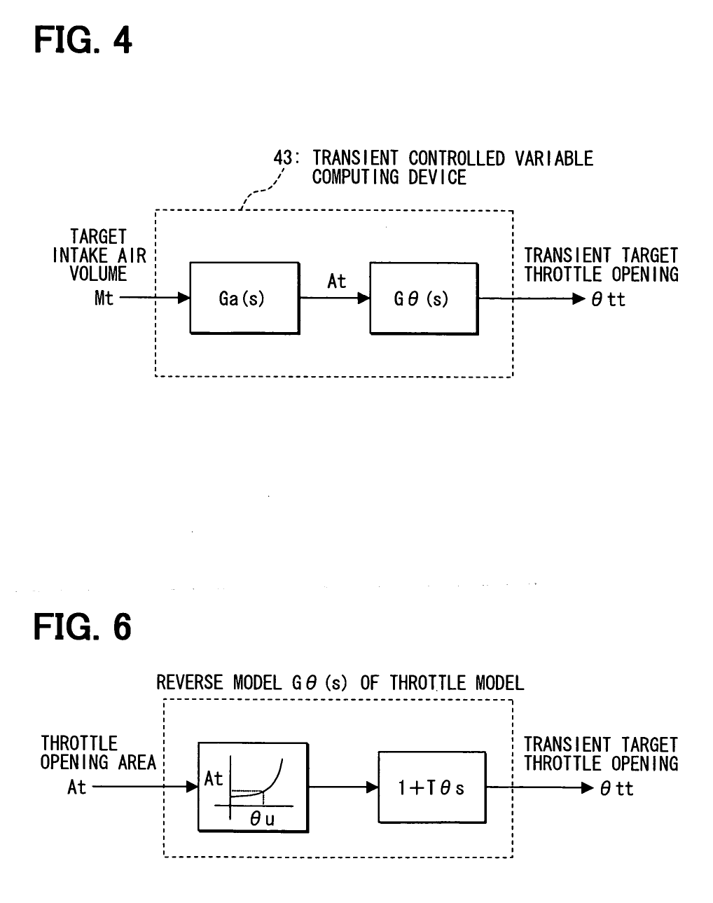

As shown in FIG. 4, the transient controlled variable computing device 43 is constructed of a reverse model of a model which considers a delay in response of an electronic throttle system, a delay in response of the intake valve 28, and a delay in response caused by the volume of an intake air passage (i.e., reverse model Ga(s) of an intake air system model and a reverse model Gθ(s) of a throttle model). This transient controlled variable computing device 43 computes the transient target throttle opening, θtt, for realizing the target intake air volume, Mt, in the transient state using a reverse model of a response model of the intake air volume to a change in the target throttle opening (i.e., reverse model Ga(s) of an intake air system model and a reverse model Gθ(s) of a throttle model).

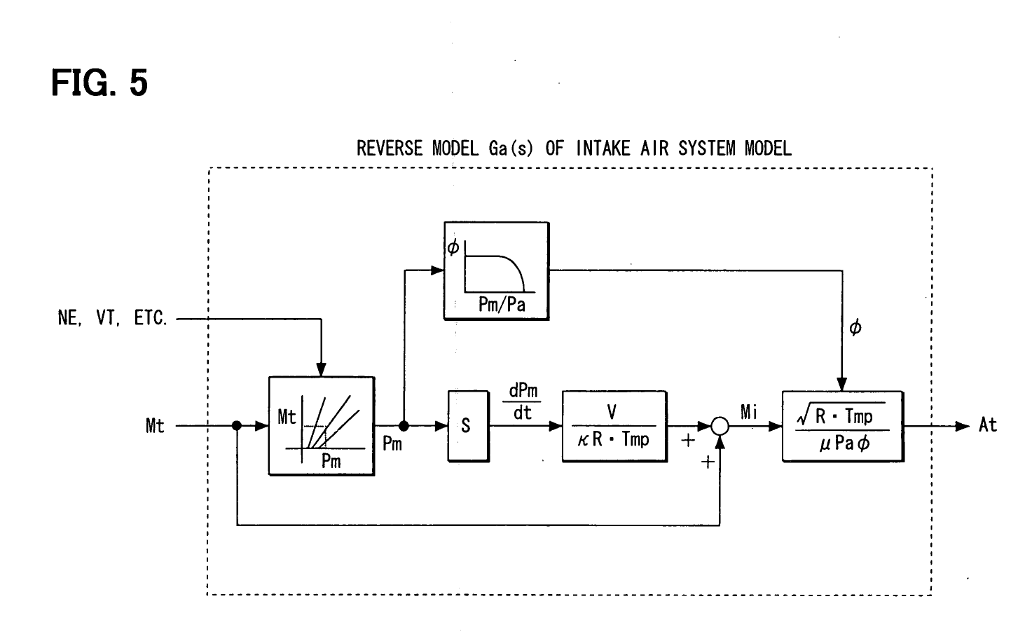

The transient controlled variable computing device 43 first converts the target intake air volume, Mt, to a throttle opening area, At, by the reverse model, Ga(s), of the intake air system model and then converts the throttle opening area, At, to the transient target throttle opening, θtt, by the reverse model, Gθ(s), of a throttle model. The constructions of these reverse models, Ga(s), Gθ(s), will be described by the use of block diagrams in FIG. 5 and FIG. 6. These block diagrams show the respective routines, which will be described later, as the flow of control parameters.

As shown in FIG. 5, the reverse model Ga(s) of the intake air system utilizes a linear relationship established between an intake pipe pressure, Pm, and an intake air volume. As such, the reverse model Ga(s) computes an intake pipe pressure, Pm, necessary for realizing the target intake air volume, Mt, using a map having a target intake air volume, Mt, as a parameter. In this embodiment, since the linear relationship between an intake pipe pressure, Pm, and an intake air volume varies according to an engine revolution speed, NE, and an intake valve timing, VT, the map for converting the target intake air volume, Mt, to the intake pipe pressure, Pm, is a map also having the engine revolution speed, NE, and the intake valve timing, VT, as parameters. A throttle-passing air volume, Mi, is determined necessary for realizing the intake pipe pressure, Pm, computed with this map.

In general, the following relationship is established between the intake pipe pressure Pm and the throttle-passing air volume Mi:

$$\frac{ⅆ Pm}{ⅆ t} = \frac{κ \cdot R \cdot Tmp}{V} ( Mi - Mt ) \qquad ( 1 )$$

where, κ is the ratio of intake air to specific heat, R is a gas constant of intake air, and Tmp is an intake air temperature. From the above equation (1), the throttle-passing air volume Mi for realizing the intake pipe pressure Pm is expressed by the following equation:

$$Mi = Mt + \frac{V}{κ \cdot R \cdot Tmp} \cdot \frac{ⅆ Pm}{ⅆ t} \qquad ( 2 )$$

Here, the difference (Pm−Pmold) between the present value, Pm, of the intake pipe pressure and the last value, Pmold, is used as the differential value with respect to time (dPm/dt) of the intake pipe pressure, Pm.

Moreover, the throttle-passing air volume, Mi, is expressed by the following equation using the throttle opening area, At:

$$Mi = \frac{μ \cdot Pa \cdot ϕ}{\sqrt{R \cdot Tmp}} \cdot At \qquad ( 3 )$$

where μ is a flow matching coefficient, Pa is atmospheric pressure, and φ is a flow coefficient determined by the intake pipe pressure, Pm, and the atmospheric pressure, Pa. From the above equation (3), the throttle opening area, At, necessary for realizing the throttle-passing air volume, Mi, can be determined. By the above-mentioned method, the throttle opening area, At, necessary for realizing the target intake air volume, Mt, is determined.

The reverse model, Gθ(s), of the throttle model, as shown in FIG. 6, determines the transient target throttle opening, θtt, necessary for realizing the throttle opening area, At. The relationship between the throttle opening area, At, and a throttle opening, θu, at that time is non-linear and the transient target throttle opening, θtt, is computed by the use of a one-dimensional map having a throttle opening, θu, as a parameter.

When a signal of transient target throttle opening, θtt, is inputted to the drive circuit of the motor 15 of the electronic throttle device so as to drive the throttle valve 16, the motor 15 is rotated to drive the throttle valve 16 to cause a delay in response before an actual throttle opening, θu, reaches the transient target throttle opening, θtt. Therefore, the following equation is established between the transient target throttle opening, θtt, and the actual throttle opening θu.

$$θ tt = \frac{1}{1 + T θ \cdot s} \cdot θ u \qquad ( 4 )$$

where Tθ is a time constant of delay in response of the throttle opening. The transient target throttle opening, θtt, for realizing the throttle opening area, At, can be determined by the use of a reverse model of this first-order delay model, that is, a first-order advance model.

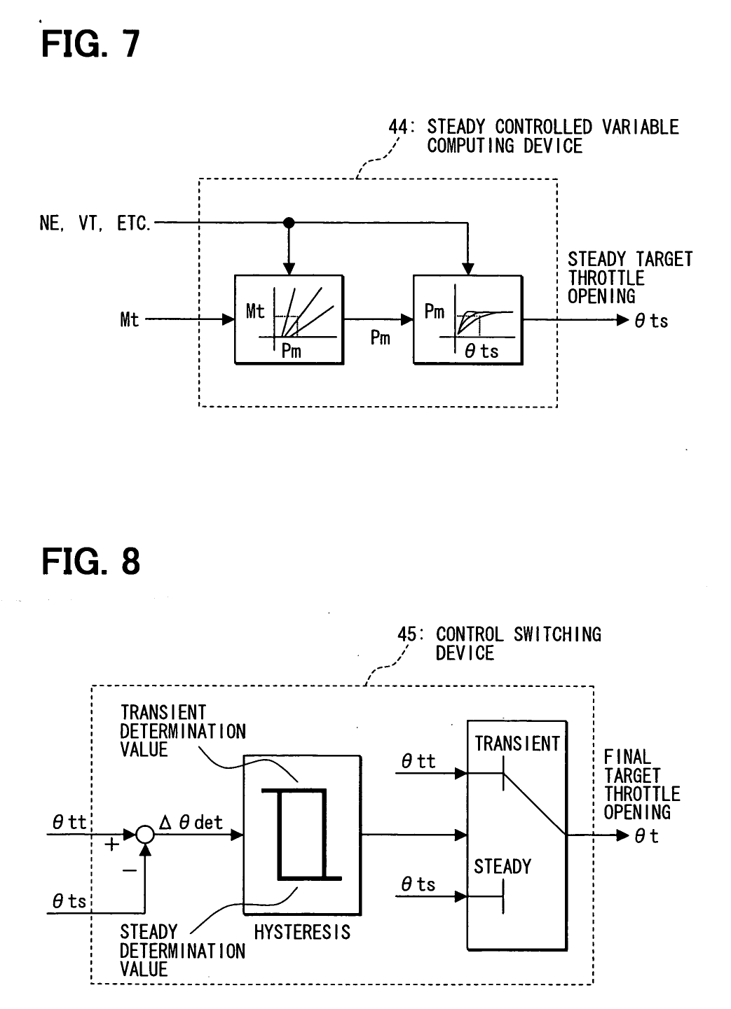

As shown in FIG. 7, in comparison with the model for computing the transient target throttle opening, θtt, the steady controlled variable computing device 44 computes a steady target throttle opening, θts, by the use of a simple model not including a time element in the following manner. First, the intake pipe pressure, Pm, is determined for realizing the target intake air volume, Mt, using a map having the target intake air volume, Mt, as a parameter. In this embodiment, since the linear relationship between the intake pipe pressure, Pm, and an intake air volume varies according to the engine revolution speed, NE, and the intake valve timing, VT, the map for converting the target intake air volume, Mt, to the intake pipe pressure, Pm, is a map also having the engine revolution speed, NE, and the intake valve timing, VT, as parameters.

The steady target throttle opening, θts, necessary for realizing the intake pipe pressure, Pm, is computed with the map. Here, since the relationship between the intake pipe pressure, Pm, and the throttle opening varies in the steady state according to the engine revolution speed, NE, and the intake valve timing, VT, the map for converting the intake pipe pressure, Pm, to steady target throttle opening, θts, is a map having also the engine revolution speed, NE, and the intake valve timing, VT, as parameters.

As shown in FIG. 8, the control switching device 45 computes the difference Δθdet between the transient target throttle opening θtt and the steady target throttle opening θts (i.e., Δθdet=|θtt−θts|). The control switching device 45 compares the difference, Δθdet, with a determination value to thereby select either of the transient target throttle opening, θtt, and the steady target throttle opening, θts, as a final target throttle opening, θt. In this embodiment, in order to develop hysteresis in the switching between the transient target throttle opening, θtt, and the steady target throttle opening, θts, there are set two kinds of determination values of a transient determination value and a steady determination value smaller than the transient determination value. If the present driving state is a steady state, the difference, Δθdet, is compared with the transient determination value. When the difference, Δθdet, exceeds the transient determination value, the driving state is determined to be transient and is switched to a state where the transient target throttle opening, θtt, is a final target throttle opening, θt. By contrast, if the present driving state is a transient state, the difference, Δθdet, is compared with the steady determination value smaller than the transient determination value and when the difference, Δθdet, becomes smaller than the steady determination value, the driving state is determined to be steady and is switched to a state where the steady target throttle opening, θts, is a final target throttle opening, θt.

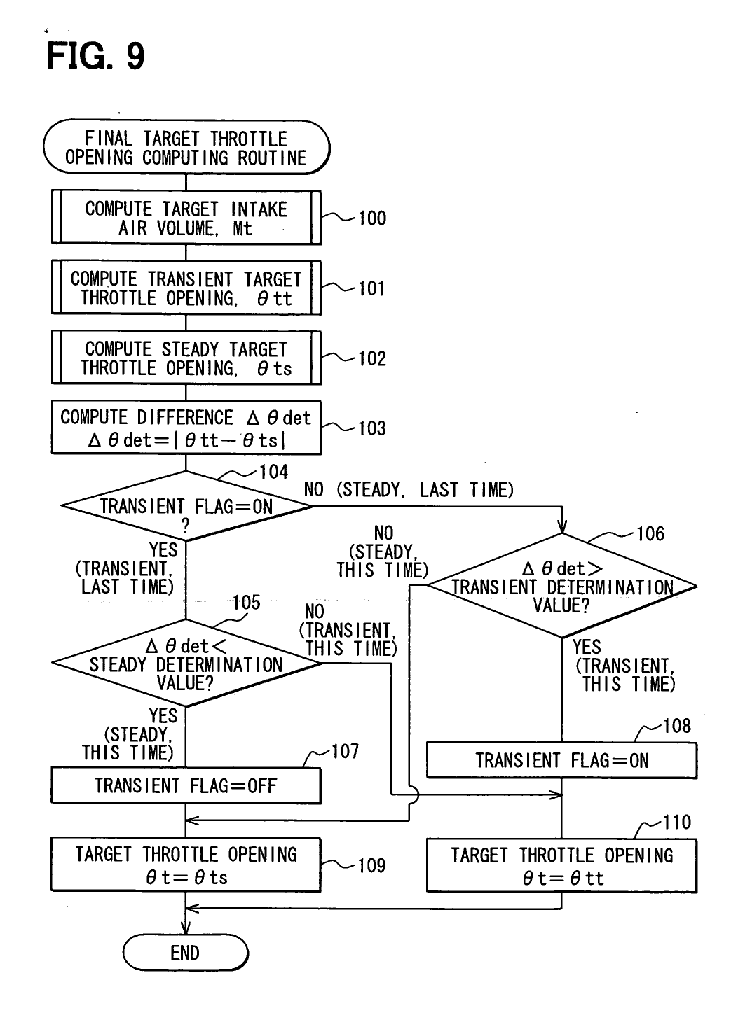

The engine control of this embodiment described above is performed according to the respective routines in FIG. 9 to FIG. 13 by the ECU 30. Hereinafter, the processing contents of these respective routines will be described.

[Final Target Throttle Opening Computing Routine]

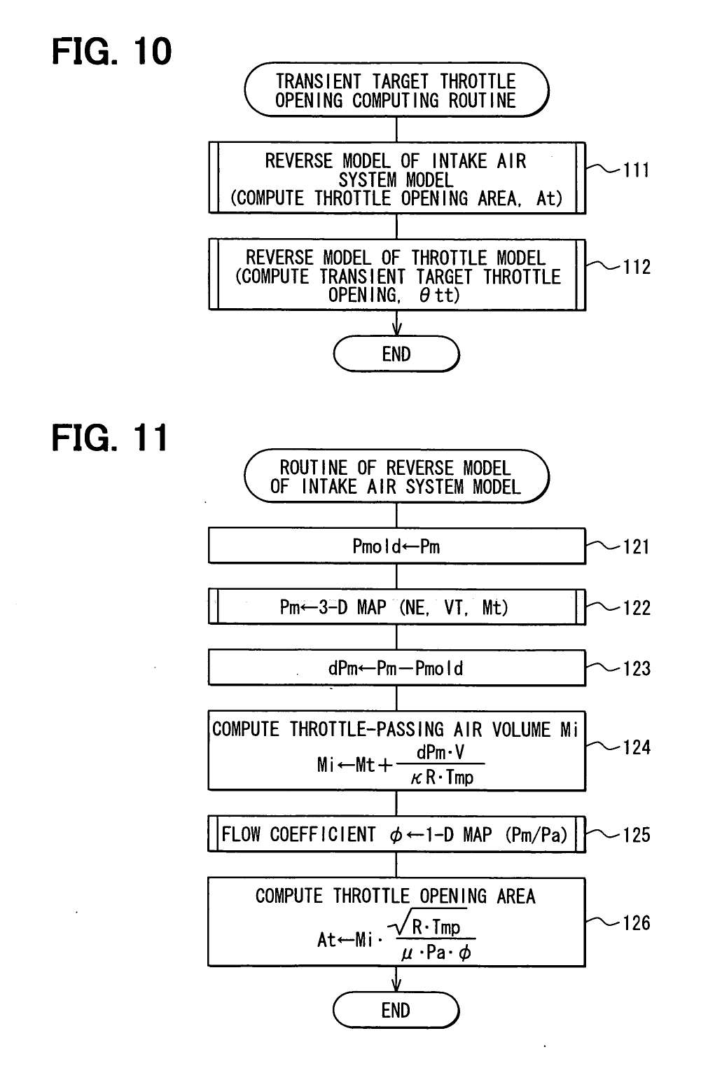

A final target throttle opening computing routine in FIG. 9 is executed at specified intervals while the engine is being driven. This routine begins in Step 100, wherein the target intake air volume, Mt, according to the present engine revolution speed, NE, and a target torque are computed by the use of a two-dimensional map. Then, the routine proceeds to Step 101 where a transient throttle opening computing routine (FIG. 10) is executed to compute a transient target throttle opening, θtt, as will be described in greater detail below. Then, the routine proceeds to Step 102 where a steady throttle opening computing routine (FIG. 13) is executed to compute a steady target throttle opening θts as will be described in greater detail below.

Thereafter, the routine proceeds to Step 103 where the difference Δθdet between the transient target throttle opening, θtt, and the steady target throttle opening, θts, is computed (i.e., Δθdet=|θtt−θts|).

Thereafter, the routine proceeds to Step 104 to determine whether the engine was in the transient state last time by determining whether a transient flag is ON. If the transient flag is ON (i.e., if the engine was in the transient state last time), the routine proceeds to Step 105 to determine whether the state of engine is switched from “transient state” to “steady state” by determining whether the difference Δθdet is smaller than the steady determination value. If the difference Δθdet is smaller than the steady determination value, it is determined that the state of engine is switched from “transient state” to “steady state,” and the routine proceeds to Step 107. In Step 107, the transient flag is set at “OFF,” and then routine proceeds to Step 109 where the steady target throttle opening, θts, is set at the final target throttle opening, θt. By contrast, if it is determined that the difference Δθdet is not smaller than the steady determination value in the above-mentioned Step 105, it is determined that the engine has been continuously in the transient state since the last time, and the routine proceeds to Step 110 where the transient target throttle opening, θtt, is set at the final target throttle opening, θt.

Moreover, if it is determined in the above-mentioned Step 104 that the transient flag is OFF (i.e., it is determined that the engine was in the steady state last time), the routine proceeds to Step 106. In Step 106, it is determined whether the state of the engine is switched from “steady state” to “transient state” by determining whether the difference Δθdet is larger than the transient determination value. If the difference Δθdet is larger than the steady determination value, it is determined that the state of engine is switched from “steady state” to “transient state,” and the routine proceeds to Step 108 where the transient flag is set at “ON.” Then, the routine proceeds to Step 110 where the transient target throttle opening, θtt, is set at the final target throttle opening θt. By contrast, if it is determined in Step 106 that the difference Δθdet is not larger than the transient determination value, it is determined that the engine has been continuously in the steady state since the last time and the routine proceeds to Step 109 where the steady target throttle opening θts is set at the final target throttle opening θt.

[Transient Target Throttle Opening Computing Routine]

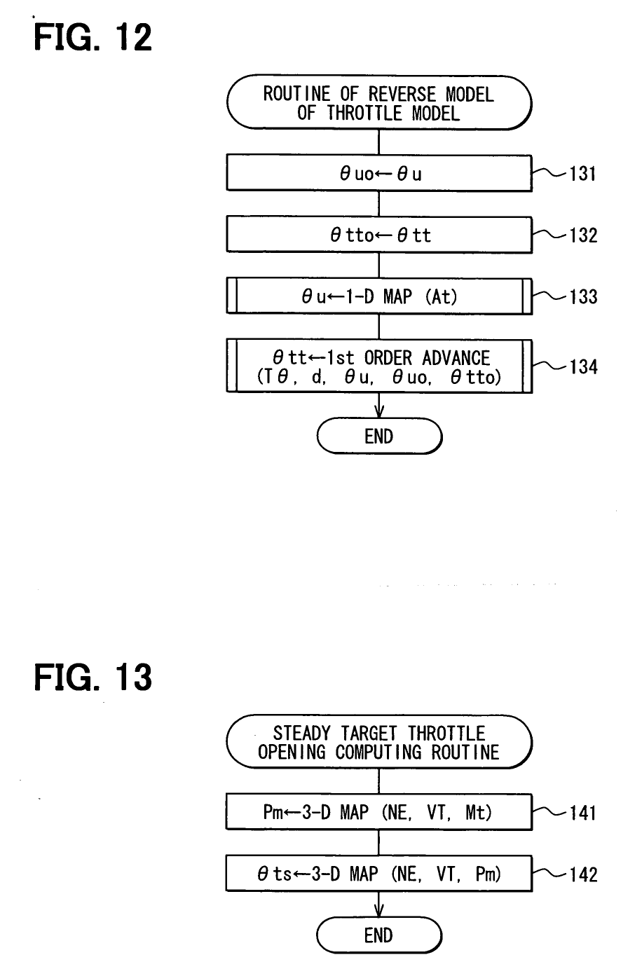

A transient target throttle opening computing routine in FIG. 10 is a sub-routine executed in Step 101 of the above-mentioned final target throttle opening computing routine in FIG. 9. The routing begins in Step 111, wherein a routine of a reverse model of an intake air system model (FIG. 11) is executed to compute a throttle opening area, At, necessary for realizing the target intake air volume Mt, as will be described in greater detail below. Thereafter, the routine proceeds to Step 112 where a routine of a reverse model of a throttle model (FIG. 12) is executed to compute a transient target throttle opening, θtt, for realizing the throttle opening area, At, as will be described in greater detail below.

[Routine of Reverse Model of Intake Air System Model]

The routine of the reverse model of the intake air system model in FIG. 10 is a subroutine executed in Step 111 of the above-described transient target throttle opening computing routine of FIG. 10. As shown in FIG. 11, the routine begins in Step 121, wherein the last intake pipe pressure, Pm, is stored as Pmold in memory (e.g., RAM). Then, the routine proceeds to Step 122 where an intake pipe pressure, Pm, according to the present engine revolution speed, NE, the intake valve timing, VT, and the target intake air volume, Mt, is computed by the use of a three-dimensional map. Thereafter, the routine proceeds to Step 123 to get the difference dPm between the present value of the intake pipe pressure, Pm, and the last value, Pmold (i.e., dPm=Pm−Pmold).

Thereafter, the routine proceeds to Step 124 where the throttle-passing air volume, Mi, is computed by the use of the above-mentioned equation (2). Next, the routine proceeds to Step 125 where a flow coefficient, φ, according to the ratio (Pm/Pa) of the intake pipe pressure Pm to the atmospheric pressure Pa is computed by the use of a one-dimensional map. Then, in Step 126, the throttle opening area, At, necessary for realizing the throttle-passing air volume, Mi, is computed by the use of the following equation:

$$At = Mi \cdot \frac{\sqrt{R \cdot Tmp}}{μ \cdot Pa \cdot ϕ} \qquad ( 5 )$$

This equation can be derived from the above-mentioned equation (3).

A routine of a reverse model of a throttle model in FIG. 12 is a subroutine executed in Step 112 of the above-mentioned transient target throttle opening computing routine of FIG. 10. The routine begins in Step 131, wherein a last actual throttle opening θu is stored as θuo in memory (e.g., RAM). Then, in Step 132, a last transient target throttle opening, θtt, is stored as θtto in memory (e.g., RAM). Thereafter, the routine proceeds to Step 133 where the throttle opening area, At, is converted to an actual throttle opening, θu, by the use of a one-dimensional map. Thereafter, the routine proceeds to Step 134 where the actual throttle opening, θu, is subjected to a first-order advance processing to thereby determine a transient target throttle opening, θtt, for realizing the throttle opening area, At.

The steady target throttle opening computing routine of FIG. 13 is a subroutine executed in Step 102 of the above-mentioned final target throttle opening computing routine in FIG. 9. The routine begins in Step 141, wherein the intake pipe pressure, Pm, according to the present engine revolution speed NE, the intake valve timing VT, and the target intake air volume Mt are computed by the use of a three-dimensional map. Thereafter, the routine proceeds to Step 142 where the steady target throttle opening, θts, according to the present engine revolution speed, NE, the intake valve timing, VT, and the intake pipe pressure, Pm, are determined by the use of a three-dimensional map.

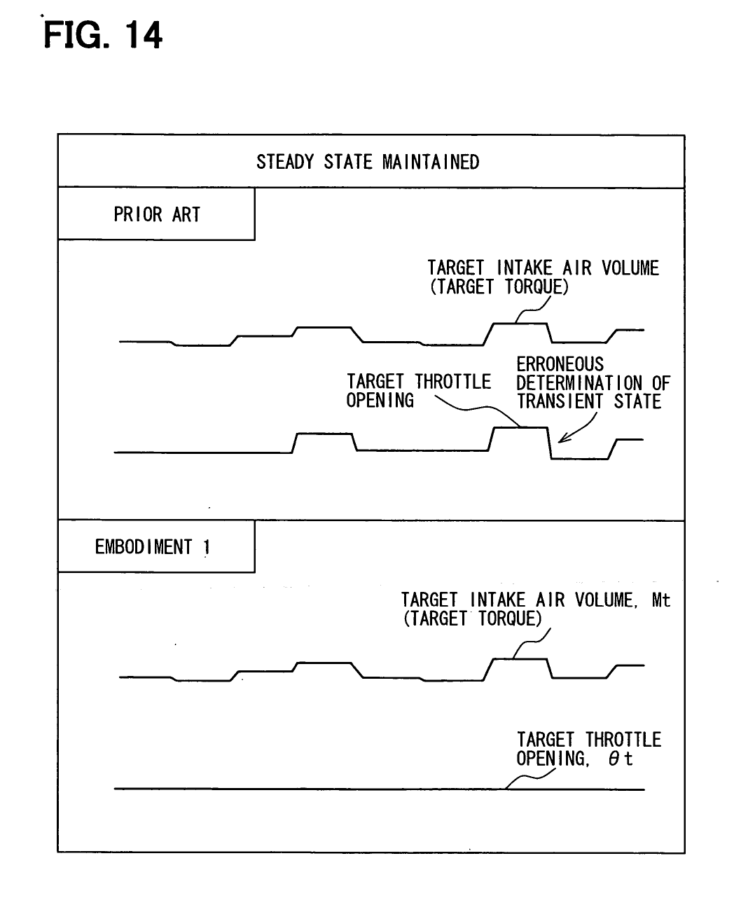

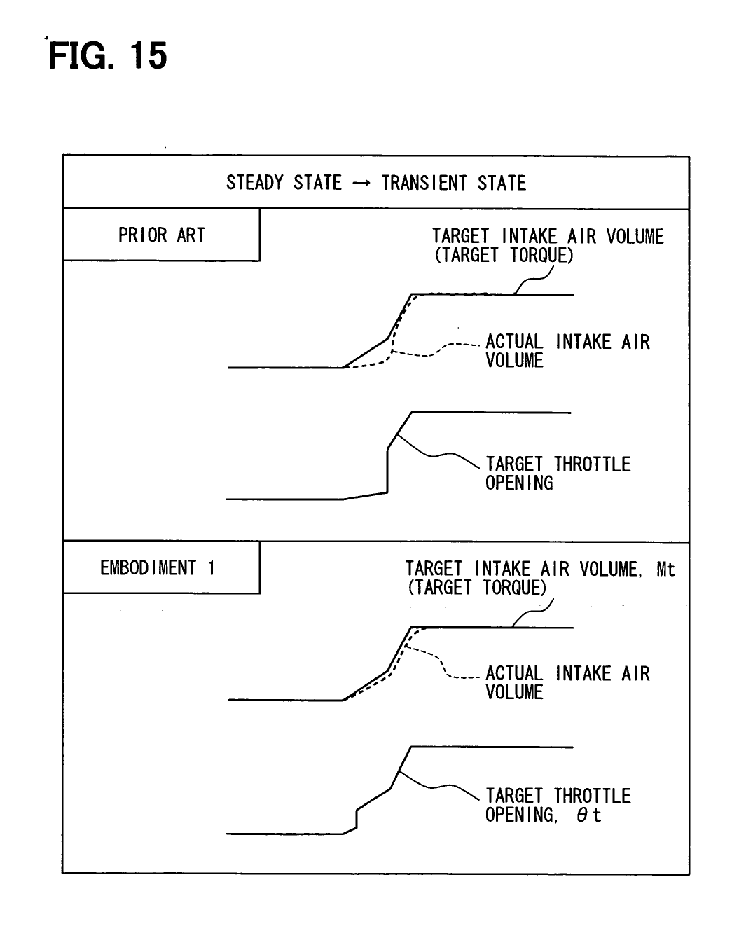

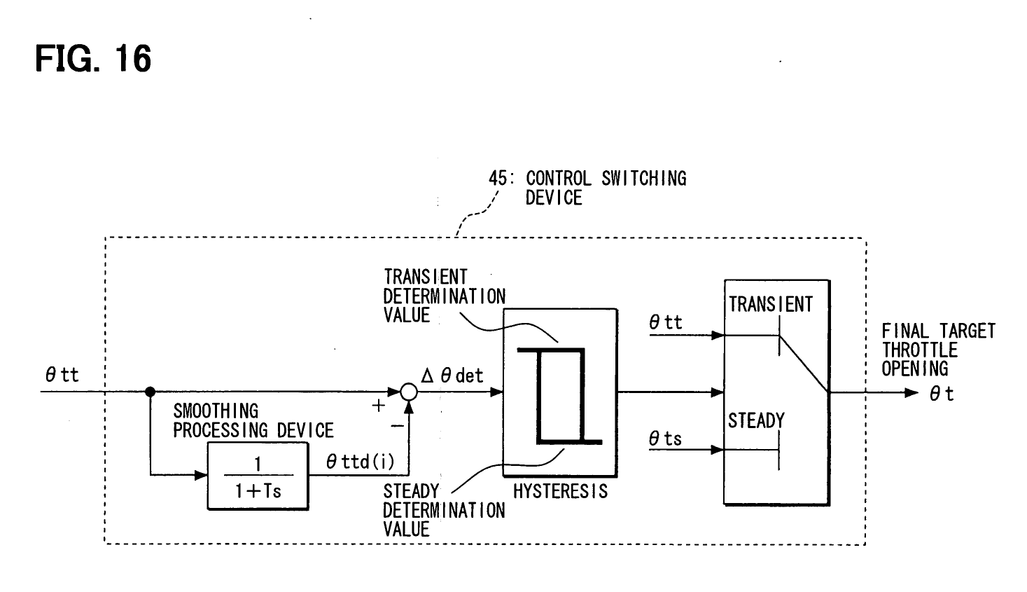

The operation and effect of the embodiment described above are evident when comparing it to the prior art as shown in FIGS. 14 and 15.

Here, FIG. 14 shows the behavior of a target throttle opening, θtt, when the target intake air volume, Mt, (i.e., target torque) is vibrated by noise of the accelerator sensor 36 and the like when the vehicle is running in a steady state. In the prior art system, there is a case where even when the vehicle is running in the steady state, when the target intake air volume, Mt, (i.e., target torque) is vibrated by noise of the accelerator sensor 36 and the like, the vibration is erroneously determined to be a transient state to change a target throttle opening in the steady state to a target throttle opening in the transient state. As a result, although the vehicle is running in the steady state, the target throttle opening in the steady state is vibrated by noise to reduce stability in the steady state.

However, for the embodiment described above, regardless of whether the engine is in the steady state or in the transient state, both of the transient target throttle opening, θtt, and the steady target throttle opening, θts, are computed at specified intervals and the difference Δθdet between the transient target throttle opening, θtt, and the steady target throttle opening, θts, is compared with the determination value to thereby determine whether the engine is in the steady state or in the transient state. As such, even if a sensor signal or the like used for computing the transient target throttle opening, θtt, and the steady target throttle opening, θts, are vibrated by noise, the transient target throttle opening, θtt, and the steady target throttle opening, θts, are vibrated in the same direction along with the vibration, so that the effect of noises exerted on the difference Δθdet between them is substantially cancelled. Hence, if this difference Δθdet is compared with the determination value to thereby determine whether the engine is in the steady state or in the transient state in the embodiment described above, it is possible to avoid erroneous determination of the engine steady state or engine transient state. Hence, the stability of the steady target throttle opening θt can be improved. In addition, when it is determined that the engine is in the transient state, the transient target throttle opening, θtt, computed by giving a higher priority to responsivity than to stability is set at the final target throttle opening θt. Therefore, the responsivity of the transient target throttle opening θtt can be also improved.

By contrast, FIG. 15 shows the behavior of the steady target throttle opening, θt, when the driving state is switched from the steady state to the transient state. In the prior art, the determination whether the engine is in the steady state or in the transient state is made on the basis of the engine driving condition and the target throttle opening is switched. As a result, there is a case where the difference between the target throttle opening before the switching and the target throttle opening after the switching is increased. This raises the possibility of developing a torque shock.

However, in the embodiment described above, the difference Δθdet between the transient target throttle opening, θtt, and the steady target throttle opening, θts, is compared with the determination value to thereby determine whether the engine is in the steady state or in the transient state (i.e., to switch between the transient target throttle opening, θtt, and the steady target throttle opening, θts). Hence, the difference Δθdet between the transient target throttle opening, θtt, and the steady target throttle opening, θts, at the time of switching between the transient target throttle opening, θtt, and the steady target throttle opening, θts, can be controlled to a constant value (i.e., determination value). That is, the embodiment described above is less likely to produce torque shock, which is caused at the time of switching between the transient target throttle opening, θtt, and maintains an approximately steady target throttle opening, θts.

In addition, in the embodiment described above, hysteresis is developed in switching between the transient target throttle opening, θtt, and the steady target throttle opening, θts. Hence, the embodiment described above is less likely to produce a chattering phenomenon switching between the transient target throttle opening θtt and the steady target throttle opening θts.

In the embodiment described above, the difference Δθdet between the transient target throttle opening, θtt, and the steady target throttle opening, θts, is compared with the determination value to thereby determine whether the engine is in the steady state or in the transient state. However, the ratio between the transient target throttle opening, θtt, and the steady target throttle opening, θts, (i.e., θtt/θts or θts/θts) may be compared with a determination value to thereby determine whether the driving state is the steady state or the transient state. In this manner, the method of comparing the transient target throttle opening, θtt, and the steady target throttle opening, θts, may be changed as appropriate.

### Embodiment 2

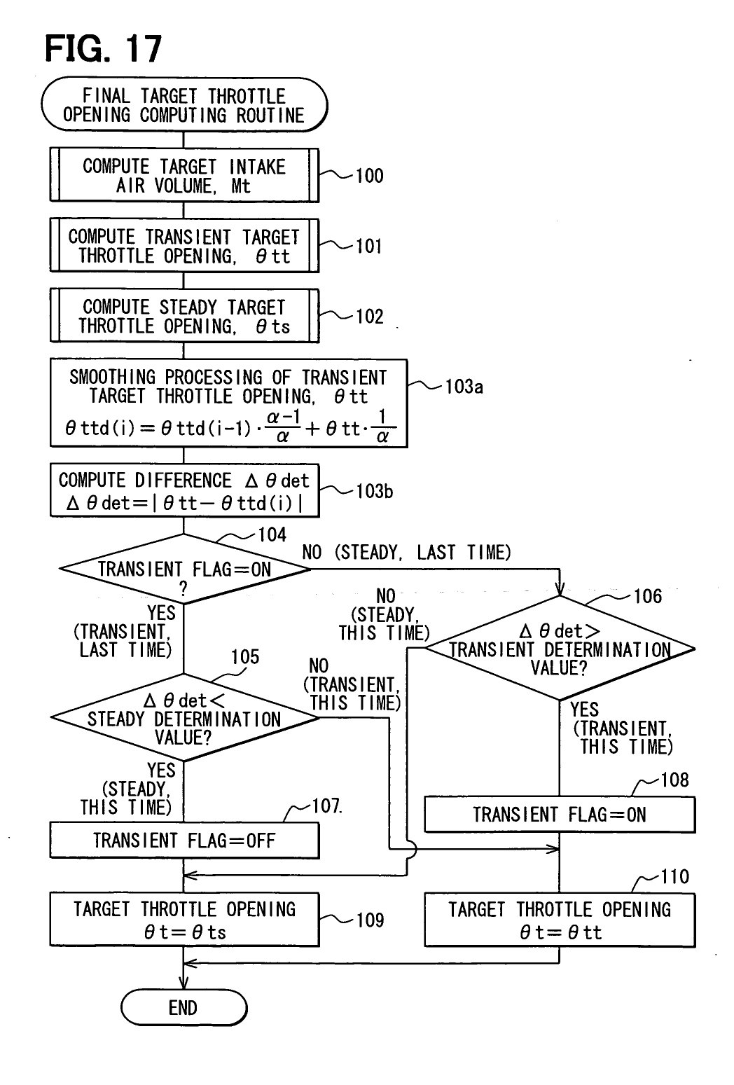

In the above-described embodiment, the difference Δθdet between the transient target throttle opening, θtt, and the steady target throttle opening, θts, is compared with the determination value to thereby determine whether the engine is in the steady state or in the transient state. However, another embodiment represented in FIGS. 16 and 17 has a smoothing processing device for smoothing out a transient target throttle opening, θtt, and compares a difference Δθdet between the transient target throttle opening, θtt, and its smoothed value θttd(i) with a determination value to thereby determine whether the driving state is the steady state or the transient state. Other aspects of this embodiment are similar to the embodiment described above in connection to FIGS. 1-15.

The final target throttle opening computing routine for this embodiment is shown in FIG. 17. The routine is similar to that of FIG. 9, except that Step 103 is changed by Steps 103a and 103b.

In the final target throttle opening computing routine of FIG. 17, the target intake air volume Mt, the transient target throttle opening θtt, and the steady target throttle opening θts are computed in Steps 100 to 102. Then, the routine proceeds to Step 103a where the transient target throttle opening θtt is subjected to smoothing processing by the following equation to thereby determine the transient target throttle opening smoothed value θttd(i):
θttd(i)=θttd(i−1)×(α−1)/α+θtt×1/α
where θttd(i−1) is the last transient target throttle opening smoothed value and α is a smoothing coefficient. Here, the smoothing processing is sometimes referred to as “first-order delay processing” or “filter processing.”

Thereafter, the routine proceeds to Step 103b where the difference Δθdet between the transient target throttle opening, θtt, and its smoothed value, θttd(i), is computed according to the following equation:
Δθdet=|θtt−θttd(i)|

The processing after Step 104 is executed similar to the embodiment described above in connection with FIGS. 1-15 to determine the final target throttle opening θt.

In the embodiment of FIGS. 16 and 17, even if a sensor signal and the like used at the time of computing the transient target throttle opening, θtt, are vibrated by noise, the transient target throttle opening, θtt, and its smoothed value, θttd(i), are vibrated in the same direction along with the vibration, so that the effect of noise exerted on the difference Δθdet between them is nearly cancelled. Hence, if the difference Δθdet between the transient target throttle opening, θtt, and its smoothed value, θttd(i), is compared with a determination value to thereby determine whether the engine is in the steady state or in the transient state (to switch between the transient target throttle opening, θtt, and the steady target throttle opening, θts), as described in this embodiment, it is possible to prevent an erroneous determination that the engine is in the steady state or in the transient state due to noise and hence to strike a balance between stability in the steady state and responsivity in the transient state.

In this regard, in this embodiment, the difference Δθdet between the transient target throttle opening, θtt, and its smoothed value, θttd(i), is compared with the determination value to thereby determine whether the engine is in the steady state or in the transient state. However, the ratio between the transient target throttle opening, θtt, and its smoothed value, θttd(I), (i.e., (θtt/θttd(i) or θttd(i)/θtt)) may be compared with a determination value to thereby determine whether the engine is in the steady state or in the transient state. In this manner, the method of comparing the transient target throttle opening, θtt, and its smoothed value, θttd(i), may be changed as appropriate.

It will be appreciated that the scope of application of the present invention is not limited to a throttle control system but can be widely applied to a control system that determines whether something to be controlled is in the steady state or in the transient state and switches between a controlled variable in the steady state and a controlled variable in the transient state.

In addition, the application of the present invention is not limited to a direct injection engine, but the present invention can be variously modified and put into practice without departing from the spirit and scope of the present invention. For example, the control device can be applied to an intake port injection engine.

Thus, while only the selected preferred embodiments have been chosen to illustrate the present invention, it will be apparent to those skilled in the art from this disclosure that various changes and modifications can be made therein without departing from the scope of the invention as defined in the appended claims. Furthermore, the foregoing description of the preferred embodiments according to the present invention is provided for illustration only, and not for the purpose of limiting the invention as defined by the appended claims and their equivalents.

What is claimed is:

1. A control device of an engine comprising:
a steady controlled variable computing device for computing a steady controlled variable appropriate for a steady operation of the engine;
a transient controlled variable computing device for computing a transient controlled variable appropriate for a transient operation of the engine; and
a controller that compares the steady controlled variable with the transient controlled variable and selects one of the steady controlled variable and the transient controlled variable on the basis of the comparison.

2. The control device of claim 1, wherein the controller computes a difference between the steady controlled variable and the transient controlled variable and selects the steady controlled variable when the difference is within a specified value and selects the transient controlled variable when the difference exceeds the specified value.

3. The control device of claim 1, wherein the controller causes hysteresis to develop in switching between the steady controlled variable and the transient controlled variable.

4. The control device of claim 1, wherein the steady controlled variable computing device computes an engine controlled variable, which gives a higher priority to stability than to responsivity-to-change in a target value, as the steady controlled variable, and wherein the transient controlled variable computing device computes an engine controlled variable, which gives a higher priority to responsivity than to stability, as the transient controlled variable.

5. A control device of an engine comprising:
a steady controlled variable computing device for computing a steady controlled variable appropriate for a steady operation of the engine;
a transient controlled variable computing device for computing a transient controlled variable appropriate for a transient operation of the engine;
a smoothing processing device for smoothing processing of the transient controlled variable to get a smoothed value; and
a controller that compares the transient controlled variable with the smoothed value and selects one of the steady controlled variable and the transient controlled variable on the basis of the comparison.

6. The control device according to claim 5, wherein the controller computes a difference between the transient controlled variable and the smoothed value and selects the steady controlled variable when the difference is within a specified value and selects the transient controlled variable when the difference exceeds the specified value.

7. The control device according to claim 5, wherein the controller causes hysteresis to develop in switching between the steady controlled variable and the transient controlled variable.

8. The control device according to claim 5, wherein the steady controlled variable computing device computes an engine controlled variable, which gives a higher priority to stability than to responsivity-to-change in a target value, as the steady controlled variable, and wherein the transient controlled variable computing device computes an engine controlled variable, which gives a higher priority to responsivity than to stability, as the transient controlled variable.

9. A method of controlling an engine comprising:
computing a steady controlled variable appropriate for a steady operation of the engine;
computing a transient controlled variable appropriate for a transient operation of the engine;
comparing the steady controlled variable with the transient controlled variable; and
selecting one of the steady controlled variable and the transient controlled variable on the basis of the comparing.

10. The method of claim 9, further comprising computing a difference between the steady controlled variable and the transient controlled variable, selecting the steady controlled variable when the difference is within a specified value, and selecting the transient controlled variable when the difference exceeds the specified value.

11. The method of claim 9, further comprising causing hysteresis to develop in switching between the steady controlled variable and the transient controlled variable.

12. The method of claim 9, further comprising computing an engine controlled variable, which gives a higher priority to stability than to responsivity-to-change in a target value, as the steady controlled variable, and computing an engine controlled variable, which gives a higher priority to responsivity than to stability, as the transient controlled variable.

13. A method of controlling an engine comprising:
computing a steady controlled variable appropriate for a steady operation of the engine;
computing a transient controlled variable appropriate for a transient operation of the engine;
smoothing processing of the transient controlled variable to get a smoothed value;
comparing the transient controlled variable with the smoothed value; and
selecting one of the steady controlled variable and the transient controlled variable on the basis of the comparison.

14. The method according to claim 13, further comprising computing a difference between the transient controlled variable and the smoothed value, selecting the steady controlled variable when the difference is within a specified value, and selecting the transient controlled variable when the difference exceeds the specified value.

15. The method according to claim 13, further comprising causing hysteresis to develop in switching between the steady controlled variable and the transient controlled variable.

16. The method according to claim 13, further comprising computing an engine controlled variable, which gives a higher priority to stability than to responsivity-to-change in a target value, as the steady controlled variable, and computing an engine controlled variable, which gives a higher priority to responsivity than to stability, as the transient controlled variable.
